(19) United States
(12) Patent Application Publication
(10) Pub. No.: US 2014/0123715 A1
(43) Pub. Date: May 8, 2014

(54) Locking System for Storage Container

(71) Applicant: KNAACK LLC, Crystal Lake, IL (US)

(72) Inventors: Robert A. Bergum, Woodstock, IL (US); Gerald A. Draffkorn, Woodstock, IL (US)

(73) Assignee: KNAACK LLC, Crystal Lake, IL (US)

(21) Appl. No.: 13/667,697

(22) Filed: Nov. 2, 2012

(51) Int. Cl. E05B 65/52; E05B 15/00

(52) U.S. Cl. 70/78; 70/320

(57) ABSTRACT

A locking system for a storage compartment of a storage container is provided, the locking system including a latching mechanism and a locking mechanism. When the locking mechanism is in a locked position, the latching mechanism is prevented from unlatching and opening the compartment. When the locking mechanism is in its unlocked position, the latching mechanism is allowed to be unlatched and the compartment to be moved to its open position. The key code used with the locking mechanism may be the same or different than the key code used with the locking system of another storage compartment of the storage container.

### BACKGROUND

1. Field of the Application

The present invention relates generally to a jobsite storage container, and more particularly to a locking system for securing a storage compartment of a jobsite storage container.

2. Description of the Related Art

Jobsite storage containers such as tool boxes and storage cabinets are used at construction job sites and similar locations for storing items such as tools and materials. The contents stored in these storage containers typically are protected from theft by means of locks. The containers generally have a single storage compartment for storing items. With a single storage compartment, it is oftentimes difficult to locate smaller items that may have made their way past larger, bulker items to the bottom of the compartment. On occasion, a user may need to secure some of the contents of the compartment while having free access to other contents of the compartment. Understandably, that is challenging to accomplish when the storage container has a single compartment.

Thus, there is a need for a storage container that provides a number of storage compartments, each with its own locking system, for securely storing tools and materials. With such a storage container having more than one storage compartment, there is a further need to provide the user with the freedom to use either the same key code or a different key code for the locking systems of the different storage compartments.

These as well as other aspects and advantages will become apparent to those of ordinary skill in the art by reading the following detailed description, with reference where appropriate to the accompanying drawings. Further, it should be understood that the embodiments described in this summary and elsewhere are intended to illustrate the invention by way of example only.

### SUMMARY

In accordance with one aspect of the present invention, a locking system for use in a storage container is provided. The storage container has a body including a storage compartment for securely storing items. The locking system comprises a locking mechanism provided on the storage compartment of the storage container, the locking mechanism movable between a locked position and an unlocked position. The locking system further comprises a latching mechanism provided adjacent to the locking mechanism on the storage compartment, the latching mechanism movable between a latched position and an unlatched position. The latching mechanism includes a latch that engages the body of the storage container for preventing the storage compartment from being opened. The latching mechanism further includes a latch rod that interacts with the locking mechanism to prevent the latching mechanism from moving to its unlatched position. The latching mechanism further includes a handle for rotating the latch between the latched position and the unlatched position. When the locking mechanism is in its locked position, the latching mechanism is prevented from being moved to its unlatched position, thereby preventing the storage compartment from being opened. When the locking mechanism is in its unlocked position, the latching mechanism may be moved to its unlatched position, thereby allowing the storage compartment to be opened.

In accordance with another aspect of the present invention, a storage container for securely storing items is provided. The storage container comprises a body including a first storage compartment with a locking system and a second storage compartment with a locking system and a key code. The locking system of the first compartment comprises a locking mechanism provided on the first compartment of the storage container, the locking mechanism having a locked position, an unlocked position, and a key code. The locking system further comprises a latching mechanism provided adjacent to the locking mechanism on the first compartment, the latching mechanism having a latched position and an unlatched position. The latching mechanism includes a latch that engages the body of the storage container to prevent the first compartment from being unlatched. The latching mechanism further includes a latch rod that interacts with the locking mechanism to prevent it from moving to its unlatched position. The latching mechanism further includes a handle for rotating the latch between the latched position and the unlatched position. When the locking mechanism is in its locked position, the latching mechanism is prevented from being moved to its unlatched position and the first compartment is prevented from being opened. When the locking mechanism is in its unlocked position, the latching mechanism can be moved to its unlatched position and the first compartment can be opened.

In accordance with yet another aspect of the present invention, a locking system for use in a storage container is provided. The storage container has a body defining a storage compartment, the compartment having an open position that allows access to contents of the compartment and a closed position that prevents access to contents of the compartment. The locking system comprises a lock box for holding a lock inside the compartment. The locking system further comprises a latching mechanism provided on a surface of the compartment, the latching mechanism including a latch, a latch rod, and a rotatable handle. The latch is rotatably mounted on the surface of the compartment and is movable between a latched position and an unlatched position. The latch in the latched position prevents the compartment from moving from its closed position to its open position, and the latch in the unlatched position allows the compartment to move from its closed position to its open position. The latch rod is operatively coupled with the latch. The latch rod in the latched position is blocked from movement by the lock and in the unlatched position is allowed to move past the lock. The handle is rotatably mounted on the surface of the compartment and operatively coupled to the latch and the latch rod. The handle rotates the latch between the latched and unlatched positions and causes the latch rod to be moved in a linear direction between the latched and unlatched positions.

### BRIEF DESCRIPTION OF THE DRAWINGS

The invention will now be explained in relation to the accompanying drawings.

FIG. 1 illustrates a perspective view of a storage container embodying a locking system of the present invention.

FIG. 2 illustrates a front view of the storage container of FIG. 1, showing the locking system in the locked position and the drawer in the closed, latched position.

FIG. 3(a) illustrates an alternate perspective view of the storage container of FIG. 1.

FIG. 3(b) illustrates an exploded perspective view of the locking system used with the container of FIG. 3(a), the locking system shown in the locked position.

FIG. 4 illustrates a side view of the locking system of FIG. 3(b).

FIG. 5 illustrates a perspective view of the locking system of FIG. 3(b), the locking system shown in the unlocked position.

FIG. 6 illustrates the locking system of FIG. 5 with the biasing spring.

### DETAILED DESCRIPTION

The invention will now be described with reference to the accompanying drawings that do not limit the scope and ambit of the invention. The description provided is purely by way of example and illustration, and in no way limits the scope thereof.

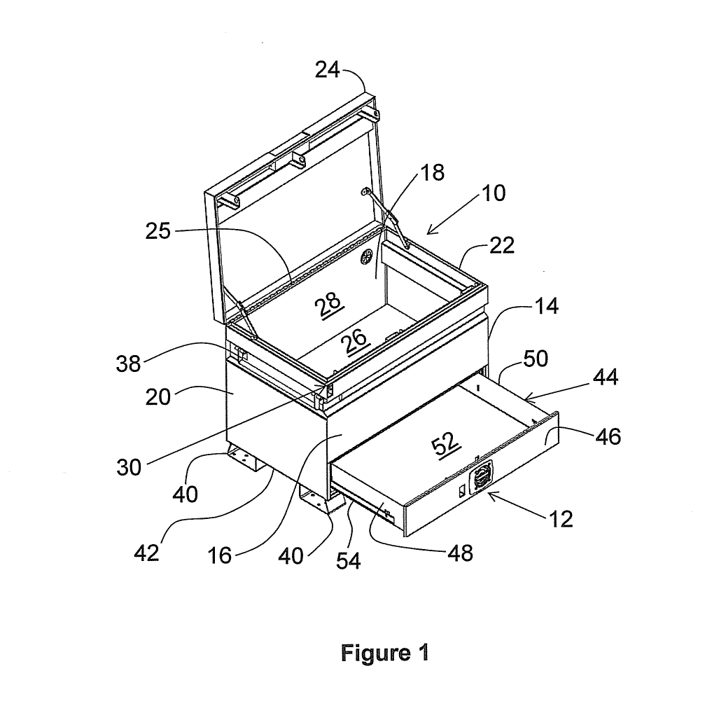

FIG. 1 depicts a storage container 10 with which the locking system 12 of the present invention may be used. The storage container 10 includes a body 14 comprising a front wall 16, a back wall 18, two side walls 20, 22 extending between the front and back walls, a top cover or lid 24 pivotably mounted to the back wall 18 by suitable hinge means 25, and a compartment bottom wall 26, together defining an upper level storage compartment 28. In order to secure its contents, the upper compartment 28 is provided with a locking system 30, specifically Knaack LLC's WATCHMAN® IV lock system, which is the subject matter of U.S. Pat. No. 6,772,613, the subject matter of which is hereby incorporated by reference. The locking system 30 for the upper compartment 28 utilizes a padlock (not shown) with a key code chosen by the user. For purposes of this application, the term “key code” denotes the key required to unlock a particular lock. The container 10 further is provided with handles 38 on each side wall for facilitating its movement and foot pads 40 on a container bottom wall 42 for supporting the container upon a surface.

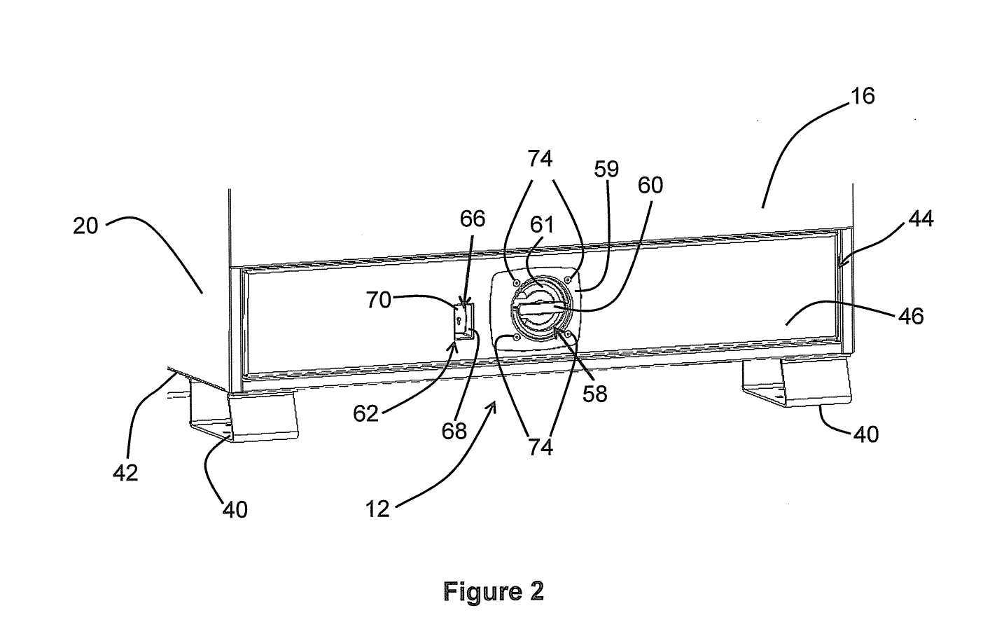

The storage container 10 further includes a lower level storage compartment 44, which may take the form of a drawer. The drawer 44 includes a front wall 46, a back wall (not shown), two side walls 48, 50 extending between the front and back walls, and a bottom wall 52. The side walls 48, 50 are each provided with a slide 54 along an exterior surface. The slides 54 mate with channels (not shown) provided on a lower interior surface of the side walls 20, 22 of the storage container. The slides and channels enable the drawer to slide between an open position (shown in FIG. 1) and a closed position (shown in FIG. 2). Alternatively, any other suitable opening or sliding mechanism may be used. The drawer 44 is provided with the locking system 12 of the present invention, which will be described in detail below.

Turning now to FIG. 2, a front view of the locking system 12 of the present invention is shown. The system 12 includes a latching mechanism 58 and a locking mechanism 66. The latching mechanism 58 is mounted on the front wall 46 of the drawer 44 and includes a handle body 59. The handle body 59 may take the form of a stamping. The latch mechanism 58 is further provided with a rotatable handle 60 positioned in a recess 61 on the front face of the handle body 59. The handle 60 is used to move or rotate the mechanism between a latched position and an unlatched position. In the embodiment shown in FIG. 2, the handle 60 is of the type referred to as a D handle. It should be understood that other suitable rotatable latch mechanisms may be used.

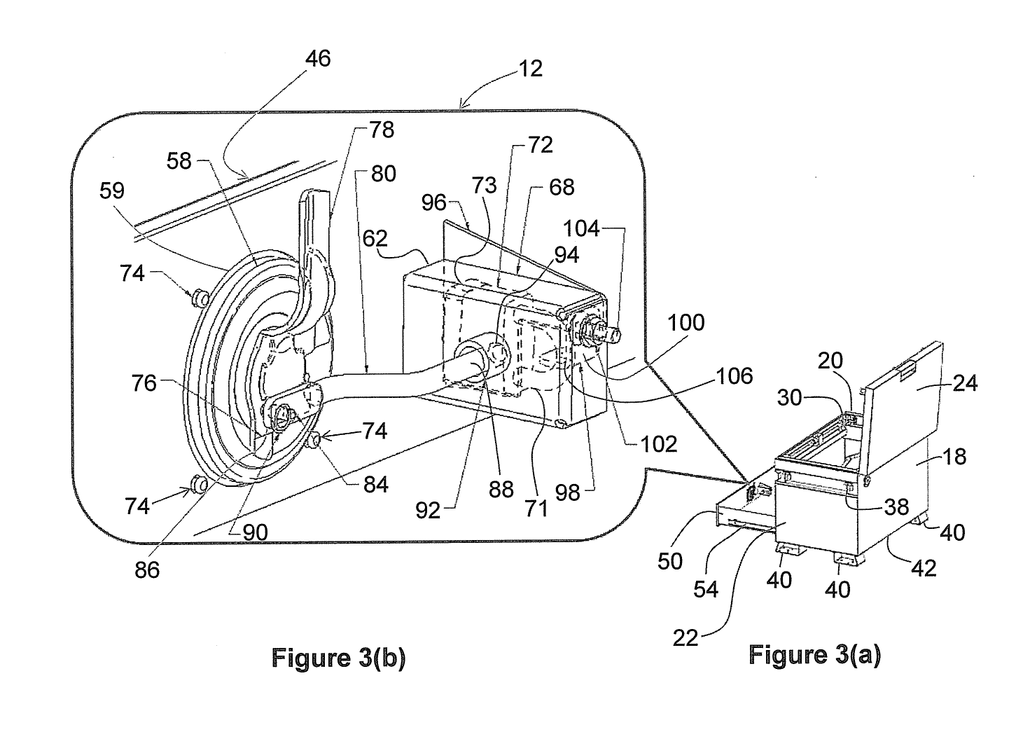

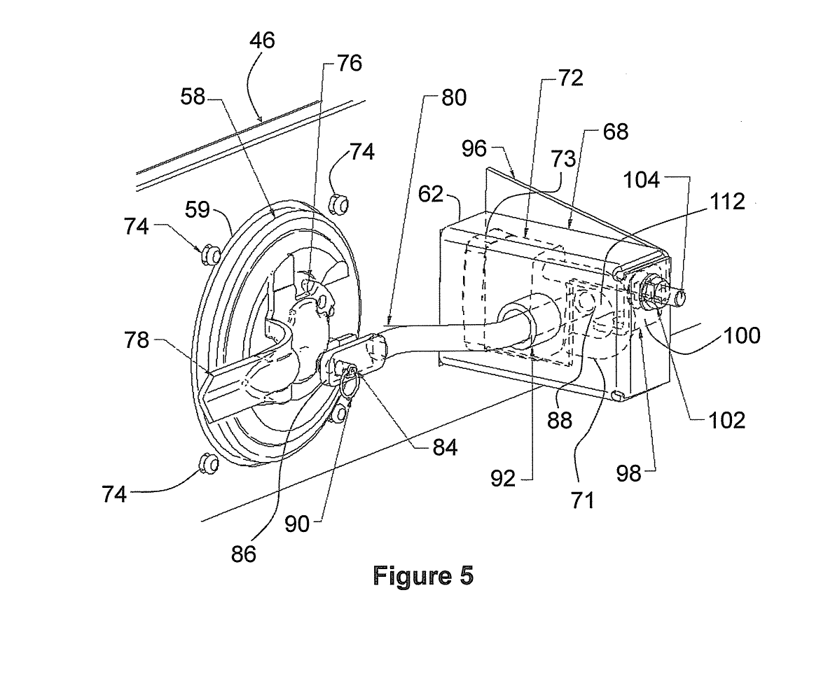

Adjacent to the latching mechanism 58 on the front wall 46 of the drawer 44, an opening 62 is provided, behind which is mounted the locking mechanism 66. The locking mechanism 66 includes a lock box 68 for housing a lock 70 and supporting the same within the drawer. In FIG. 2, the lock system 12 is shown in the locked position as indicated by the lock 70 being withdrawn within the lock box 68. As can be seen best in FIGS. 3(b) and 5, the lock 70 comprises a padlock having a shackle 71, a padlock body 72, and a key insertion surface 73. The lock 70 also has a key code that is chosen by the user. It should be understood that other suitable locks may be used.

Referring now to FIGS. 3(a) and (b), FIG. 3(a) illustrates a perspective view of the storage container 10 while FIG. 3(b) illustrates an exploded perspective view of the locking system 12 used with the container of FIG. 3(a). In FIG. 3(b), the locking system 12 is shown in the locked position.

The latching mechanism 58 is mounted to the front wall 46 of the drawer 44 by any appropriate fasteners 74. In the embodiment shown in FIG. 3(b), rivets are used to fasten the mechanism 58 to the front wall 46. It should be understood that other appropriate fasteners may be used.

The latching mechanism 58 further includes a latch plate 76 and a latch 78. The latch plate 76 is positioned at the center of the handle body 59, with the latch 78 extending from the latch plate 76. The handle 60 is operatively coupled to the latch plate 76. Specifically, the handle 60 and the latch plate 76 are coupled together on either side of the handle body 59 by appropriate fasteners. Thus, rotation of the handle 60 causes corresponding rotation of the latch plate 76, which in turn causes corresponding rotation of the latch 78. The handle 60 is used to move or rotate the latch 78 between the latched position shown in FIG. 3(b), where the latch is upright, and the unlatched position shown in FIG. 5.

The latching mechanism 58 further includes a latch rod 80 having a proximal end 86 and a distal end 88, and a stud 84. The stud 84 is mounted off center on the latch plate 76. The proximal end 86 of the latch rod 80 is flattened and pivotably held on the stud 84 by means of a cotter pin 90. The distal end 88 of the latch rod 80 is free to slide inside a guide bush 92, which is mounted over a hole 94 provided on the lock box 68.

The lock box 68 is secured adjacent to the opening 62 on the interior surface of the front wall 46 of the drawer 44 by any appropriate method such as welding or the like. A bracket 96 is mounted on the interior surface of the front wall 46 of the drawer to provide additional security and stiffness to the lock box 68. A lock tab 98 is provided at the closed end 100 of the lock box 68 and is preferably coupled to the lock box by means of any suitable fasteners. In the embodiment shown in FIGS. 3(b) and 5, the fasteners comprise a nut 102 and a carriage bolt 104. The lock tab 98 is further provided with at least one opening 106 through which the shackle 71 of the padlock 70 may extend. When the lock 70 is placed inside the lock box 68 with the shackle 71 inserted through the opening 106 in the lock tab 98, the padlock body 72 may be pushed against the lock tab 98 to place the lock in its locked position. As can be seen in FIG. 3(b), when the lock 70 is in its locked position, the body 72 of the lock 70 prevents linear movement of the distal end 88 of the latch rod 80 toward the lock 70. This in turn prevents the latch 78 from moving out of the latched position of FIG. 3(b) to the unlatched position (shown in FIG. 5).

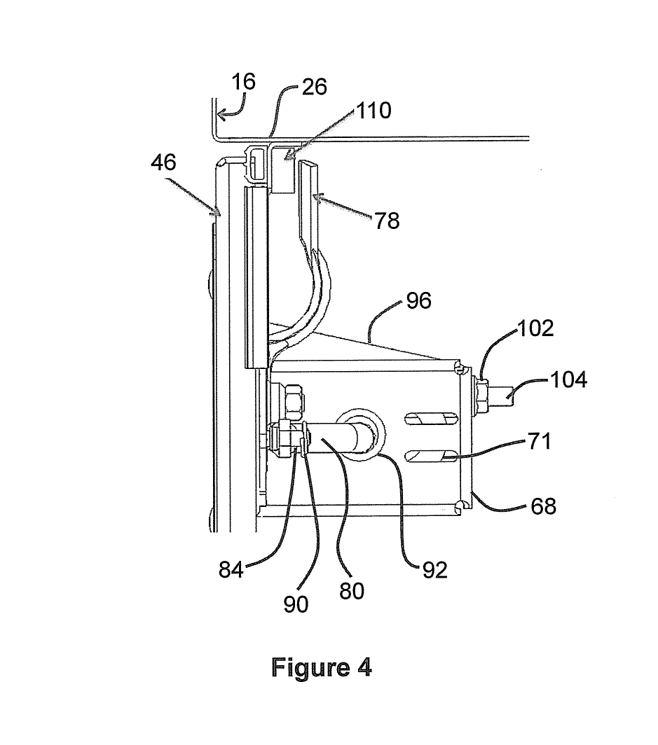

Referring to FIG. 4, the drawer 44 of the storage container is depicted in its closed position, the latching mechanism 58 is in the latched position, and the padlock 70 is locked in the lock box 68. The latch 78 of the latching mechanism engages a catch 110 that is carried on the body of the storage container, preferably on the bottom wall 26. In the orientation shown in FIG. 4, the handle 60 of the latching mechanism cannot be rotated because the padlock body 72 in the lock box 68 blocks linear movement of the distal end 88 of the latch rod 80 toward the body 72, which in turn prevents rotation of the latch plate 76. This prevents the latch 78 from moving out of engagement with the catch 110, thereby keeping the drawer 44 in the closed and latched position.

To open the drawer 44, the user must first unlock the padlock 70 housed in the lock box 68 using the appropriate key code. Since the shackle 71 is carried by the lock tab 98 and cannot move toward the lock tab, the unlocking of the padlock 70 results in the padlock body 72 moving away from the lock tab 98 toward the opening 62. Once the padlock body moves toward the opening 62, the padlock body 72 no longer blocks movement of the latch rod 80. Thus, with the lock 70 unlocked, when the handle 60 is rotated, the latch plate 76 and the stud 84 also rotate. This rotation in turn results in the distal end 88 of the latch rod 80 moving in a linear direction through the guide bush 92 and passing through the loop 112 of the shackle 71, as shown in FIG. 5. The rotation of the handle 60 also causes rotation of the latch 78, thereby moving the latch 78 out of engagement with the catch 110. With the latch 78 out of engagement with the catch 110, the mechanism 58 is unlatched, and the user can now open the drawer 44 by pulling on the handle 60.

To lock the drawer 44, the handle 60 is rotated in order to move the latch from its upright position and the drawer is pushed back into the storage container to its closed position. Once the drawer is in the closed position, the handle is rotated to return the latch to its upright position. The body 72 then can be pushed against the lock tab 98 to place the lock in its locked position. In this orientation, the drawer 44 is locked in its closed position.

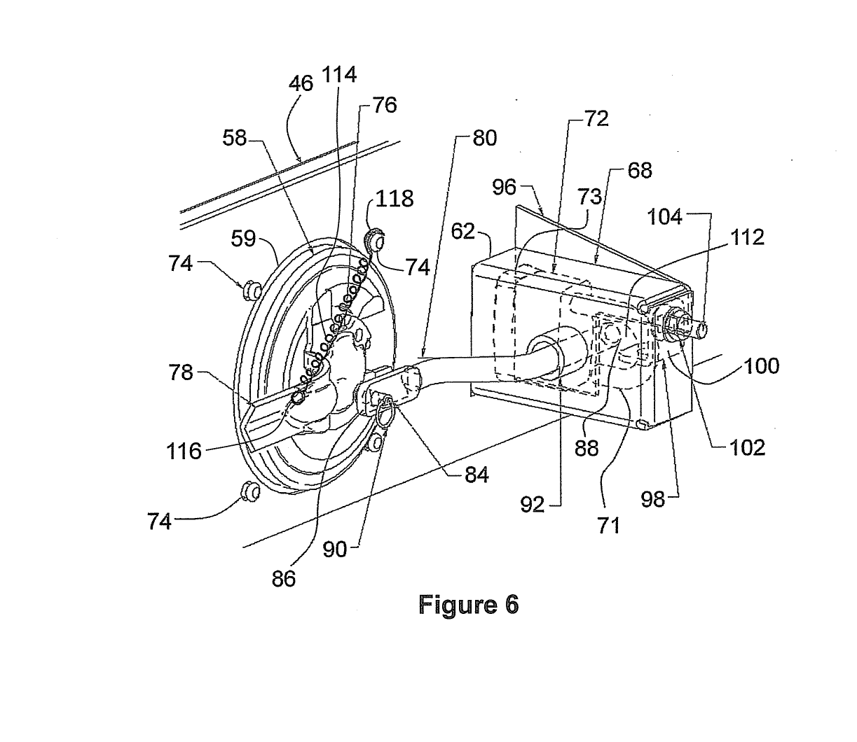

The present invention further includes a safety feature for the benefit of the user. As seen in FIG. 6, the locking system 12 further includes a spring 114 having one end 116 coupled to the latch 78 and the other end 118 coupled to one of the fasteners 74. The spring 114 biases the latch 78 of the latching mechanism 58 to the upright, latched position of FIG. 3(b). When the latch 78 is in the latched position of FIG. 3(b), the spring 114 is in its compressed state. When the latch 78 is in the unlatched position of FIG. 6, the spring 114 is in its extended state. Should the drawer 44 close unexpectedly, since the latch is biased to the upright position where it extends past a top edge of the drawer 44, the latch 78 of the latching mechanism 58 would engage the front wall 16 of the storage container, thereby preventing the drawer 44 from closing completely and trapping a user's fingers therebetween. Thus, the biasing of the latch to the latched position affords a safety feature for the user.

As can be appreciated, the upper and lower compartments of the storage container 10 provide the user with a number of options in storing tools and materials. For example, larger, bulkier items may be stored in the upper compartment while smaller, more delicate items may be stored in the lower compartment. Storing the smaller items in the drawer makes the items easier to locate and may protect them from damage. Alternately, more expensive items may be stored in the compartment that affords more security due to the type of lock used.

Further, a user may decide to lock one of the compartments while leaving the other compartment unlocked. With the container of the present invention, a user can secure certain contents in one compartment while having free access to the contents in the other compartment. This is helpful to the user that wants to secure certain items while at the same time using others. Thus, the storage container of the present invention provides advantages over the storage containers of the prior art that have a single storage compartment.

Further, the locking system provides the user with the option of having the same or a different key code for both upper level and lower level locking systems. Using the same key code for the upper level compartment as for the lower level compartment would reduce the number of keys a user must carry. Using different key codes for the two locking systems may increase the overall security afforded by the storage container. For example, using a less commonly available key code for one of the compartments would make that compartment more difficult to compromise. Further, using different key codes allows a user to manage access to the compartments of the container.

In addition, the locking system addresses the ever present concern for safety on the jobsite by providing a feature that prevents the trapping of a user's fingers between the body of the storage container and the drawer. The biasing of the latch to the upright position prevents the inadvertent closing of the drawer.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

What is claimed is:

1. A locking system for use in a storage container, the storage container having a body including a storage compartment for securely storing items, the locking system comprising:
a locking mechanism provided on the storage compartment of the storage container, the locking mechanism movable between a locked position and an unlocked position,
a latching mechanism provided adjacent to the locking mechanism on the storage compartment, the latching mechanism moveable between a latched position and an unlatched position, the latching mechanism having a latch that engages the body of the storage container for preventing the storage compartment from being opened, the latching mechanism further having a latch rod that interacts with the locking mechanism to prevent the latching mechanism from moving to its unlatched position, the latching mechanism further having a handle for rotating the latch between the latched position and the unlatched position;
wherein when the locking mechanism is in its locked position, the latching mechanism is prevented from being moved to its unlatched position, thereby preventing the storage compartment from being opened, and when the locking mechanism is in its unlocked position, the latching mechanism may be moved to its unlatched position, thereby allowing the storage compartment to be opened.

2. The locking system of claim 1, wherein the locking mechanism has a key code and the container has a second storage compartment with a second locking system and a second key code, the key code of the locking mechanism of the storage compartment and the second key code of the locking system of the second storage compartment being the same.

3. The locking system of claim 1, wherein the locking mechanism has a key code and the container has a second storage compartment with a second locking system and a second key code, the key code of the locking mechanism of the storage compartment and the second key code of the locking system of the second storage compartment being different.

4. The locking system of claim 1, wherein the locking mechanism includes a lock having a lock body, a key insertion surface, and a shackle, and a lock box mounted on the storage compartment for housing the lock.

5. The locking system of claim 4, wherein when the locking mechanism is in its locked position, the lock body prevents linear movement of the latch rod with respect to the lock body, thereby preventing the latching mechanism from moving from its latched position to its unlatched position.

6. The locking system of claim 4, wherein when the locking mechanism is in its unlocked position, the lock body allows the latch rod to move linearly with respect to the lock body, thereby allowing the latching mechanism to move to its unlatched position.

7. The locking system of claim 1, wherein in the unlatched position of the latching mechanism, the latch is out of engagement with the body of the storage container, thereby allowing the compartment to be opened.

8. The locking system of claim 1, wherein in the latched position of the latching mechanism, the latch is engages the body of the storage container, thereby preventing the compartment from being opened.

9. The locking system of claim 1, wherein said compartment is a drawer.

10. The locking system of claim 9, wherein the drawer has a front wall provided with an opening and the locking mechanism further includes a lock box positioned adjacent the opening for housing the locking mechanism.

11. The locking system of claim 9, wherein the drawer has a front wall, the handle of the latching mechanism mounted on the front wall of the drawer.

12. The locking system of claim 9, wherein the latch is biased to the latched position and extends past a top edge of the drawer in the latched position, thereby preventing the drawer from closing inadvertently.

13. A storage container for securely storing items, the storage container comprising:
a body including a first storage compartment having a locking system and a second storage compartment having a locking system with a key code, and
the locking system of the first compartment comprising:
a locking mechanism provided on the first compartment of the storage container, the locking mechanism having a locked position, an unlocked position, and a key code that unlocks the locking mechanism;
a latching mechanism provided adjacent to the locking mechanism on said first compartment, the latching mechanism having a latched position and an unlatched position;
the latching mechanism including a latch that engages the body of the storage container to prevent the first compartment from being unlatched, the latching mechanism further having a latch rod that interacts with the locking mechanism to prevent it from moving to its unlatched position, the latching mechanism further having a handle for rotating the latch between the latched position and the unlatched position;
wherein when the locking mechanism is in its locked position, the latching mechanism is prevented from being moved to its unlatched position and the first compartment is prevented from being opened, and when the locking mechanism is in its unlocked position, the latching mechanism can be moved to its unlatched position and the first compartment can be opened.

14. The storage container of claim 13 further including a catch on the body that engages with the latch of the latching mechanism for preventing the first compartment from being opened.

15. The storage container of claim 13 wherein the locking mechanism of the first storage compartment and the locking system of the second storage compartment having the same key code.

16. The storage container of claim 13 wherein the locking mechanism of the first storage compartment and the locking system of the second storage compartment having different key codes.

17. The storage container of claim 13 wherein the first compartment comprises a drawer in a lower portion of the container.

18. A locking system for use in a storage container, the storage container having a body defining a storage compartment, the compartment having an open position that allows access to contents of the compartment and a closed position that prevents access to contents of the compartment, the locking system comprising:
a lock box for holding a lock inside the compartment;
a latching mechanism provided on a surface of the compartment, the latching mechanism including a latch, a latch rod, and a rotatable handle;
the latch rotatably mounted on the surface of the compartment, the latch movable between a latched position and an unlatched position, the latch in the latched position preventing the compartment from moving from its closed position to its open position, and the latch in the unlatched position allowing the compartment to move from its closed position to its open position;
the latch rod operatively coupled with the latch, the latch rod in the latched position is blocked from movement by the lock and in the unlatched position is allowed to move past the lock; and
the handle rotatably mounted on the surface of the compartment and operatively coupled to the latch and the latch rod, the handle rotates the latch between the latched and unlatched positions, and causes the latch rod to be moved in a linear direction between the latched and unlatched positions.

19. The locking system of claim 18, wherein the lock comprises a padlock with a padlock body, a shackle, and a key insertion surface.

20. The locking system of claim 19 wherein the lock box is secured within the compartment and opens along an exterior surface of the compartment, the lock box including a lock tab for receiving the shackle of the padlock and securing the padlock to the container, the padlock body being slidably disposed within the lock box such that the key insertion surface of the padlock is exposed for external access along the container.

21. The locking system of claim 18, wherein the latch in the latched position interacts with a catch on the body of the storage container, thereby preventing the compartment from moving from its closed position to its open position.

22. The locking system of claim 18, the latching mechanism further comprises a latch plate upon which the latch is carried and with which the handle and the latch rod are coupled.

23. The locking system of claim 22, wherein a proximal end of the latch rod is coupled to the latch plate by a stud and a pin.
